(19) United States
(12) Patent Application Publication
(10) Pub. No.: US 2020/0044527 A1
(43) Pub. Date: Feb. 6, 2020

(54) VIBRATION MOTOR

(71) Applicant: AAC Technologies Pte. Ltd., Singapore City (SG)

(72) Inventors: Biming Zhang, Shenzhen (CN); Lubin Mao, Shenzhen (CN)

(21) Appl. No.: 16/527,021

(22) Filed: Jul. 31, 2019

(30) Foreign Application Priority Data
Aug. 3, 2018 (CN) 201821252597.9

(51) Int. Cl. H02K 33/02

(52) U.S. Cl. CPC H02K 33/02; B06B 1/045

(57) ABSTRACT

A vibration motor includes a housing, a coil accommodated in the housing, a vibrator and an elastic member supporting the vibrator. The vibrator including a magnetic bowl and a counterweight located at an outer side of the magnetic bowl and fixedly connected with the magnetic bowl. The magnetic bowl including a bottom wall and a side wall extending from the bottom wall towards the elastic member, and the magnetic bowl further includes a bent portion bent from the side wall towards the counterweight and abutting against the counterweight.

### TECHNICAL FIELD

The present disclosure relates to the field of acoustic design technology, specifically relates to a vibration motor.

### BACKGROUND

In related technologies, a vibration motor includes a housing, and a vibrator and an elastic piece accommodated in the housing. The vibrator including a magnetic bowl and a counterweight located at an outer side of the magnetic bowl and fixedly connected with the magnetic bowl. The elastic piece is placed on an upper face of the counterweight, an inner face of the counterweight is parallel to the outer face of the magnetic bowl, and a welded point is located at a region of the elastic piece and the counterweight.

However, in a vibration motor of the above-described structure, the elastic piece is generally an Austenite stainless steel with low heat-conduction rate, while the counterweight is of a material of high heat-conduction rate and high melting point. The counterweight generally does not melt during point welding, resulting in low strength of the welded point.

Therefore, it is necessary to provide a vibration motor of a new structure.

### BRIEF DESCRIPTION OF THE DRAWINGS

FIG. 1 is an exploded view of a vibration motor in embodiment 1 of the present disclosure.

FIG. 2 is a perspective view of the vibration motor in the embodiment 1 of the present disclosure.

FIG. 3 is a cross-sectional view along line AA of the vibration motor as shown in FIG. 2.

FIG. 4 is an exploded view of a vibration motor in embodiment 2 of the present disclosure.

FIG. 5 is a perspective view of the vibration motor in the embodiment 2 of the present disclosure.

FIG. 6 is a cross-sectional view along line BB of the vibration motor as shown in FIG. 5.

### DETAILED DESCRIPTION

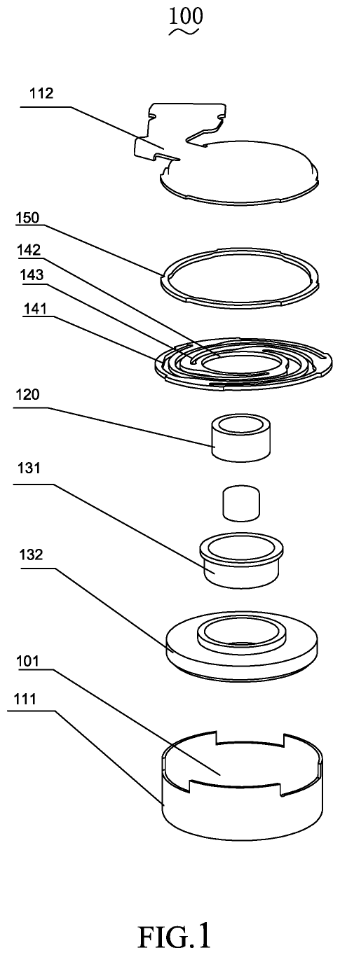

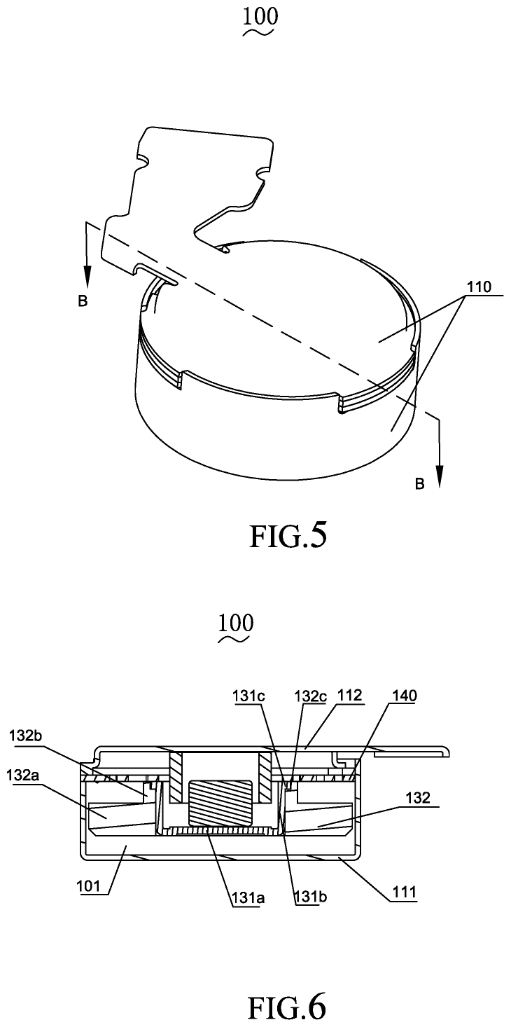

The present disclosure is described in detail with reference to FIG. 1 to FIG. 6.

### Embodiment 1

As shown in FIG. 1 to FIG. 3, the present disclosure relates to a vibration motor 100, including a housing 110, and a coil 120, a vibrator 130 and an elastic member 140 supporting the vibrator 130 those all accommodated in the housing 110. The vibrator 130 including a magnetic bowl 131 and a counterweight 132 located at an outer side of the magnetic bowl 131 and fixedly connected with the magnetic bowl 131, the magnetic bowl 131 including a bottom wall 131a and a side wall 131b extending from the bottom wall 131a towards the elastic member 140, and the magnetic bowl 131 further includes an bent portion 131c bending from the side wall 131b towards the counterweight 132 and abutting against the counterweight 132.

Specifically, when assembling the vibration motor 100 of the above-described structure, the counterweight 132 may first be assembled in the housing 110, then the magnetic bowl 131 is assembled in the counterweight 132, and the bent portion 131c shall be ensured to abut against the counterweight 132. Meanwhile, the elastic member 140 may be assembled in the housing 110 and the elastic member 140 shall be ensured to contact the bent portion 131c. Thereafter, the elastic member 140 may be welded with the bent portion 131c through point welding. In this way, surface quality of a welded point may be improved, and adhesion area between the counterweight 132 and the magnetic bowl 131 may be enlarged effectively, so that bonding strength between the counterweight 132 and the magnetic bowl 131, and bonding strength between the magnetic bowl 131 and the elastic member 140 may be increased, thereby prolonging life of the vibration motor 100 and improving user experience of the vibration motor 100.

Specifically, as shown in FIG. 1 and FIG. 3, in order to effectively elastically supporting the vibrator 130, the elastic member 140 includes an outer ring 141 fixed to the housing 110, an inner ring connected to the vibrator 130, and a connecting arm 143 that connects the outer ring 141 and the inner ring 142.

As shown in FIG. 1 and FIG. 3, in order to further increase bonding strength between the counterweight 132 and the magnetic bowl 131 and bonding strength between the magnetic bowl 131 and the elastic member 140, the bent portion 131c is sandwiched between the elastic member 140 and the counterweight 132, and the counterweight 132 is fixedly connected to the elastic member 140 through the bent portion 131c.

It shall be noted that the length of the bent portion 131c sandwiched between the elastic member 140 and the counterweight 132 is not specifically defined. That is, length of the bent portion 131c is not defined, and those skilled in the art may determine bend length of the bent portion 131c needed in accordance with what is needed. However, those skilled in the art shall understand that the bend length of the bent portion 131c shall ensure that there is a good contact area between the elastic member 140 and the bent portion 131c. Besides, there shall be a good contact area between the bent portion 131c and the counterweight 132. In this way, bonding strengths between the three may be effectively increased, and life of the vibration motor 100 may be prolonged.

Specifically, as shown in FIG. 1 and FIG. 3, the bent portion 131c may abut against the inner ring 142 of the elastic member 140.

As shown in FIG. 1 and FIG. 3, the counterweight 132 is provided with a body portion 132a and a protrusion 132b extending from the body portion 132a towards the elastic member 140 and being used for supporting the bent portion 131c. In this way, not only the bent portion 131c may be effectively supported, but also weight of the counterweight 132 may be effectively reduced, so that the size of the vibration motor 100 may be reduced.

As shown in FIG. 1 and FIG. 3, the housing 110 includes a shell 111 having an accommodating space 101 and a cover plate 112 covering the shell 111, the outer ring 141 of the elastic member 140 being sandwiched between the shell 111 and the cover plate 112.

As shown in FIG. 1 and FIG. 3, in order to prevent the cover plate 112 and the elastic member 140 from rigidly colliding with each other, a foam 150 of a hollow ring structure is further provided between the cover plate 112 and the outer ring 141 of the elastic member 140, the foam 150 being sandwiched between the cover plate 112 and the outer ring 141 of the elastic member 140.

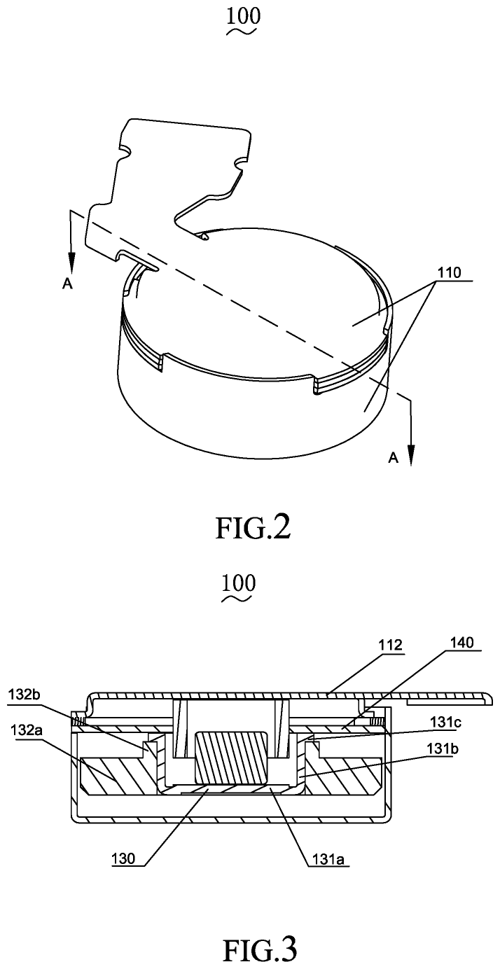

As shown in FIG. 1 and FIG. 2, in order to further reduce weight of the counterweight 132 so that the structure of the vibration motor 100 is more compact, the counterweight 132 is of a hollow ring structure, the counterweight 132 surrounding the side wall 131b of the magnetic bowl 131, and the bent portion 131c is of a continuous-ring structure.

### Embodiment 2

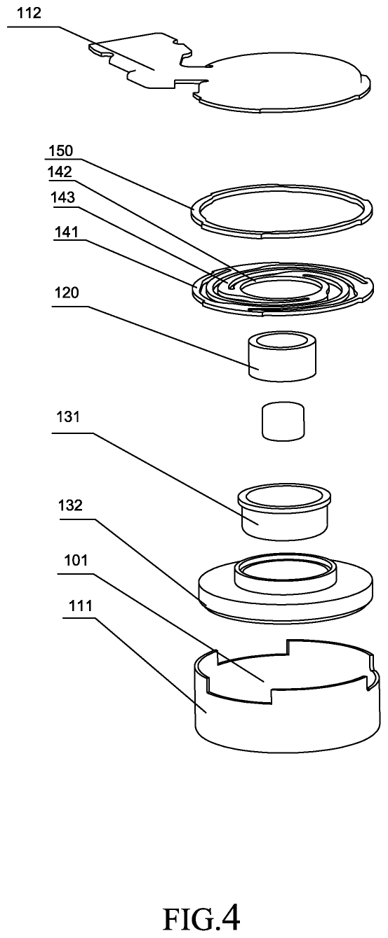

Embodiment 2 is distinguished from Embodiment 1 in that in the vibration motor 100, with reference to FIG. 4 to FIG. 6, the counterweight 132 is provided with a recess 132c accommodating the bent portion 131c.

Specifically, the bent portion 131c and a top face of the counterweight 132 may be located on the same plane, and the bent portion 131c and the counterweight 132 simultaneously abut against the inner ring 142 of the elastic member 140.

Specifically, when assembling the vibration motor 100 of the above-described structure, the counterweight 132 may first be assembled in the housing 110, then the magnetic bowl 131 may be assembled in the counterweight 132, and the bent portion 131c shall be ensured to abut against the recess 132c of the counterweight 132. Meanwhile, the elastic member 140 may be assembled in the housing 110 and the elastic member shall be ensured to contact the bent portion 131c. Thereafter, the elastic member 140 may be welded with the bent portion 131c through point welding. In this way, surface quality of a welded point can be improved, and adhesion area between the counterweight 132 and the magnetic bowl 131 can be effectively enlarged, so that bonding strength between the counterweight 132 and the magnetic bowl 131, and bonding strength between the magnetic bowl 131 and the elastic member 140 can be increased, thereby prolonging life of the vibration motor 100 and improving user experience of the vibration motor 100.

In addition to the above-described distinguishing features, concerning the rest of the structure of the vibration motor 100 in Embodiment 2, related disclosure in Embodiment 1 may be referred to and will not be repeated herein.

The above description is only some embodiments of the present disclosure. It shall be indicated that for those skilled in the art, improvement included in the scope of patent protection of the present disclosure may be performed without departing from the inventive concept of the present disclosure.

What is claimed is:

1. A vibration motor, comprising a housing, and a coil, a vibrator and an elastic member supporting the vibrator those all accommodated in the housing;
the vibrator comprising a magnetic bowl and a counterweight located at an outer side of the magnetic bowl and fixedly connected with the magnetic bowl,
the magnetic bowl comprising a bottom wall and a side wall extending from the bottom wall towards the elastic member,
wherein the magnetic bowl further comprises an bent portion bent from the side wall towards the counterweight and abutting against the counterweight.

2. The vibration motor according to claim 1, wherein the elastic member comprises an outer ring fixed to the housing, an inner ring connected to the vibrator, and a connecting arm connecting the outer ring and the inner ring.

3. The vibration motor according to claim 2, wherein the bent portion is sandwiched between the elastic member and the counterweight, and the counterweight is fixedly connected with the elastic member through the bent portion.

4. The vibration motor according to claim 3, wherein the bent portion abuts against the inner ring of the elastic member.

5. The vibration motor according to claim 2, wherein the counterweight is provided with a recess accommodating the bent portion.

6. The vibration motor according to claim 5, wherein the bent portion and a top face of the counterweight are located on the same plane, and the bent portion and the counterweight both abut against the inner ring of the elastic member.

7. The vibration motor according to claim 1, wherein the counterweight is provided with a body portion and a protrusion extending from the body portion towards the elastic member and being used for supporting the bent portion.

8. The vibration motor according to claim 2, wherein the housing comprises a shell having an accommodating space and a cover plate covering the shell, the outer ring of the elastic member being sandwiched between the shell and the cover plate.

9. The vibration motor according to claim 8, wherein a foam having a hollow ring structure is further provided between the cover plate and the outer ring of the elastic member, and the foam is sandwiched between the cover plate and the outer ring of the elastic member.

10. The vibration motor according to claim 1, wherein the counterweight is of a hollow ring structure, the counterweight surrounding the side wall of the magnetic bowl, and the bent portion is of a continuous-ring structure.
